(19) United States
(12) Patent Application Publication
(10) Pub. No.: US 2007/0147693 A1
(43) Pub. Date: Jun. 28, 2007

(54) Image coding method and image coding device

(75) Inventor: Yoshio Saito, Yokohama (JP)

Correspondence Address: ARENT FOX PLLC, 1050 CONNECTICUT AVENUE, N.W., SUITE 400, WASHINGTON, DC, 20036, US

(73) Assignees: FUJITSU LIMITED; FUJITSU DEVICES INC.

(21) Appl. No.: 11/392,644

(22) Filed: Mar. 30, 2006

(30) Foreign Application Priority Data
Dec. 27, 2005 (JP) 2005-375794

(51) Int. Cl. G06K 9/46

(52) U.S. Cl. 382/243; 382/240

(57) ABSTRACT

In a first step, an input image constituted of a region of interest and a region of non-interest is transformed into plural frequency component images through plural wavelet transforms. In a second step, part of the plural frequency component image is selected as control target images and a region corresponding to the region of interest and a region corresponding to the region of non-interest are set in each of the control target images in a unit of a predetermined coding block. In a third step, among image data of the frequency component images, image data of the region corresponding to the region of non-interest in each control target image is changed to a zero value. In a fourth step, in the unit of the coding block, bit plane coding is applied to the image data changed in the third step without changing a bit plane structure, thereby generating coded data.

### CROSS REFERENCE TO RELATED APPLICATION

This application is based upon and claims the benefit of priority from Japanese Patent Application No. 2005-375794, filed on Dec. 27, 2005, the entire contents of which are incorporated herein by reference.

### BACKGROUND OF THE INVENTION

1. Field of the Invention

The present invention relates to an image coding method and an image coding device.

2. Description of the Related Art

An image coding device in compliance with the JPEG2000 (Joint Photographic Experts Group 2000) standard has a ROI function that ensures image quality of a region of interest (ROI) in an input image with higher priority over image quality of a region of non-interest (a region excluding the region of interest in the input image) at the time of coding. The image coding device in conformity with the JPEG2000 executes the following processing when using the ROI function.

First, the input image is transformed into a plurality of frequency component images by repetition of wavelet transform, to quantize wavelet transform coefficients (image data) of the frequency component images. Next, ROI processing of scaling up wavelet transform coefficients of a region corresponding to the region of interest in each of the frequency component images is applied to the quantized wavelet transform coefficients.

Then, bit plane coding (entropy coding) is applied to the wavelet transform coefficients having undergone the ROI processing, in a unit of a predetermined coding block unit, so that coded data are generated. Thereafter, in order to make a coded stream to be newly generated conform to a target bit rate, part of the coded data are discarded as required, and the remaining portion of the coded data is combined with information about a coding condition such as quantization step size, so that the coded stream is generated.

An art relating to such a ROI function is disclosed in, for example, Japanese Unexamined Patent Application Publication Nos. 2001-45484, Sho 59-43466, and 2003-174645.

In the image coding device in conformity with the JPEG2000 standard, a data volume of the coded data is adjusted (a portion corresponding to the region of non-interest is discarded with higher priority) when the coded stream is generated, so that image quality of the region of non-interest in the coded data greatly changes according to the data volume of the region of interest in the input image. Consequently, when images forming a video image are sequentially inputted to the image coding device and the coded data generated by the image coding device are decoded to be sequentially displayed on a display device or the like, the portion corresponding to the region of non-interest is displayed in a greatly fluctuating manner.

Further, when the bit plane coding is applied, the wavelet transform coefficients of the region corresponding to the region of interest in each of the frequency component images have been scaled up, which increases the number of bit planes to be processed by the bit plane coding. Moreover, each frequency component image resulting from one wavelet transform has an area reduced to ¼, and therefore, coordinate information for determining regions corresponding to the region of interest has to be generated for all the frequency component images, in order to apply the ROI processing to all the frequency component images. Accordingly, the larger the number of times the wavelet transform is repeated is, the larger the amount of processing for generating the coordinate information is. This complicates the configuration of a circuit for realizing the ROI function.

### SUMMARY OF THE INVENTION

It is an object of the present invention to prevent image quality of a region of non-interest of coded data from greatly changing depending on a data volume of a region of interest in an input image as well as to realize a ROI function with a simple circuit configuration.

According to one aspect of the present invention, an image coding method includes the following first to fourth steps. The first step is to transform an input image constituted of a region of interest and a region of non-interest into a plurality of frequency component images through a plurality of wavelet transforms. The second step is to select a part of the plural frequency component images as control target images and setting, in a unit of a predetermined coding block, a region corresponding to the region of interest and a region corresponding to the region of non-interest in each of the control target images. The third step is to apply, to image data of the plural frequency component images, processing of changing, to a zero value, image data of the region corresponding to the region of non-interest in each of the control target images. The fourth step is to apply, in a unit of the coding block, bit plane coding to the image data changed in the third step without changing a bit plane structure, to generate coded data. An image coding device implementing this image coding method includes a transform unit executing the first step, a setting unit executing the second step, a changing unit executing the third step, and a coding unit executing the fourth step.

Since in each of the control target images the image data of the region corresponding to the region of non-interest is changed to the zero value, it is possible to prevent image quality of the region of non-interest in the coded data from greatly changing depending on the data volume of the region of interest in the input image. Further, the bit plane coding is executed without scaling up the image data of the region corresponding to the region of interest in each of the control target images, which can reduce the number of the bit planes to be processed in the bit plane coding. Moreover, the region corresponding to the region of interest and the region corresponding to the region of non-interest are set in each of the control target images in a unit of the coding block, so that pixels belonging to the region of interest and pixels belonging to the region of non-interest are not mixed up in the coding block at the time the bit plane coding is executed. Therefore, only a single processing is needed for execution of the bit plane coding within the coding block. This can realize the ROI function with a simple circuit configuration.

According to a preferable example of the aforesaid aspect of the present invention, in the second step, the frequency component image obtained through any one of the plural the wavelet transforms is selected from the plural frequency component images as the control target image.

Therefore, it has only to generate coordinate information for determining the region corresponding to the region of interest only for the frequency component image obtained through one wavelet transform, which can abate the processing for generating the coordinate information. As a result, it is possible to further simplify the circuit. According to a preferable example of the aforesaid aspect of the present invention, in the second step, the frequency component image obtained through a first one of the plural wavelet transforms is selected from the plural frequency component images as the control target image.

Therefore, only the image data of the region corresponding to the region of non-interest in the frequency component image of a high frequency component obtained through the first wavelet transform are changed to the zero value. This can reduce the deterioration in image quality of the region of non-interest in the coded data to a minimum.

Further, the image data of the frequency component images obtained through the first wavelet transform is large in data volume. Selecting the frequency component images as the control target images described above makes it possible to reduce a data volume of the coded data as a ratio of the region of non-interest to the input image increases.

According to a preferable example of the aforesaid aspect of the present invention, in the second step, the frequency component image of a lowest frequency component obtained through a final one of the plural wavelet transforms is selected from the plural frequency component images as the control target image.

Therefore, only the image data of the region corresponding to the region of non-interest in the frequency component image of the lowest frequency component obtained through the final wavelet transform are changed to the zero value. Accordingly, the region of non-interest in the coded data becomes an image substantially in one color (gray), which can realize a mask function for the region of non-interest in the input image. Such a function is adaptable to a case where, for example, it is desirable to set a portion corresponding to the region of non-interest in the input image unrecognizable when an image resulting from decoding of the coded data is displayed on a display device or the like.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram showing one embodiment of the present invention;

FIG. 2 is an explanatory view showing operations of a wavelet transform unit in the embodiment of the present invention;

FIG. 3(a) and FIG. 3(b) are explanatory views showing operations of a mask unit in the embodiment of the present invention;

FIG. 4(a) and FIG. 4(b) are explanatory charts showing an overview of coding processing in the embodiment of the present invention;

FIG. 5 is a block diagram showing a comparative example of the present invention; and

FIG. 6(a) and FIG. 6(b) are explanatory charts showing an overview of coding processing in the comparative example of the present invention.

### DESCRIPTION OF THE PREFERRED EMBODIMENTS

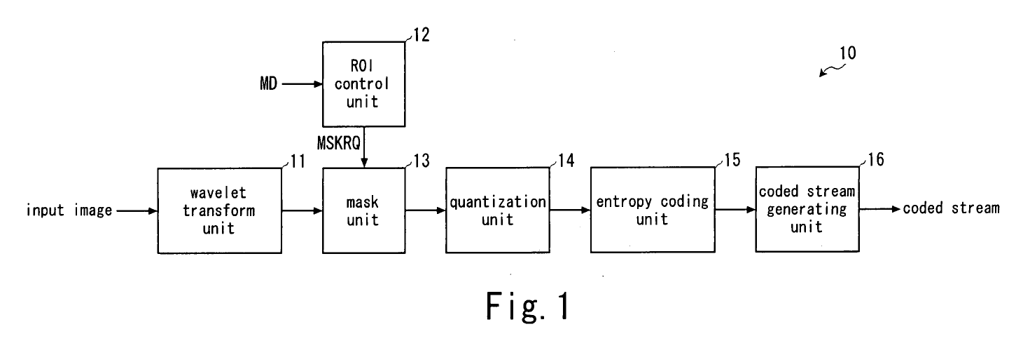

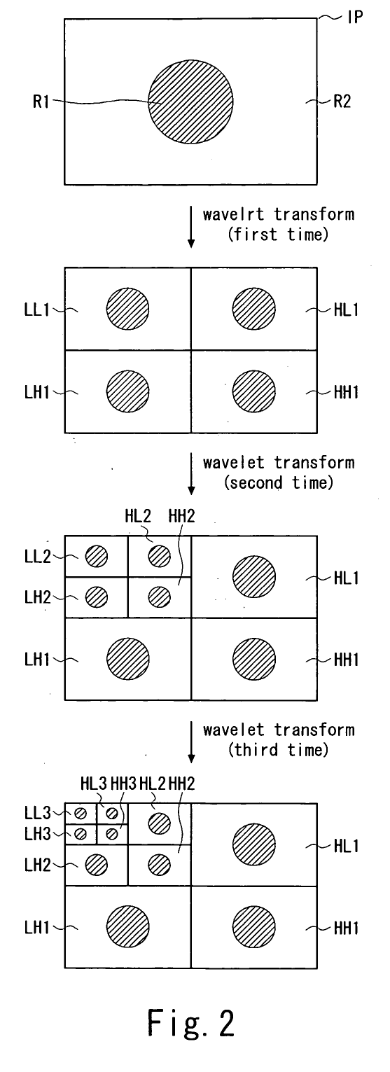

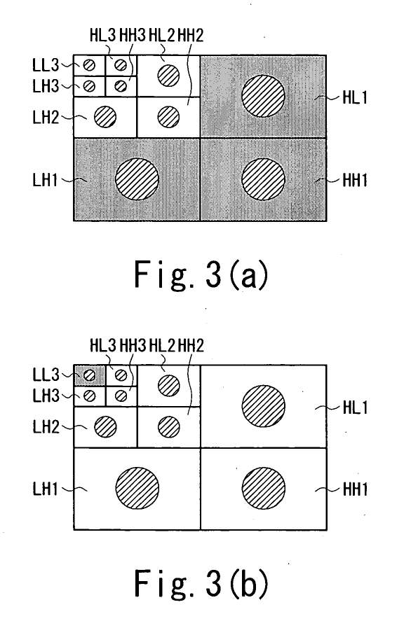

Hereinafter, an embodiment of the present invention will be described, using the drawings. FIG. 1 shows one embodiment of the present invention. FIG. 2 shows operations of a wavelet transform unit in the embodiment of the present invention. FIG. 3(a) and FIG. 3(b) show operations of a mask unit in the embodiment of the present invention.

In FIG. 1, an image coding device 10 in the embodiment of the present invention includes a wavelet transform unit 11, a ROI control unit 12, a mask unit 13, a quantization unit 14, an entropy coding unit 15, and a coded stream generating unit 16. The image coding device 10 is an image coding device in conformity with, for example, the JPEG2000 standard.

The wavelet transform unit 11 repeats wavelet transform a plurality of times to transform an input image (a YCbCr signal) into a plurality of frequency component images corresponding to different frequency components and outputs wavelet transform coefficients of the frequency component images. The description below will be given on assumed that the wavelet transform unit 11 repeats the wavelet transform three times.

As shown in FIG. 2, by the first wavelet transform, the wavelet transform unit 11 transforms an input image IP constituted of a region R1 of interest and a region R2 of non-interest into frequency component images HH1 (horizontal high frequency component, vertical high frequency component), HL1 (horizontal high frequency component, vertical low frequency component), LH1 (horizontal low frequency component, vertical high frequency component), and LL1 (horizontal low frequency component, vertical low frequency component). By the second wavelet transform, the wavelet transform unit 11 transforms the frequency component image LL1 to frequency component images HH2, HL2, LH2, LL2. By the third wavelet transform, the wavelet transform unit 11 transforms the frequency component image LL2 into frequency components images HH3, HL3, LH3, LL3. Thus, the wavelet transform unit 11 repeats the wavelet transform three times to transform the input image IP into the frequency component images HH1, HL1, LH1, HH2, HL2, LH2, HH3, HL3, LH3, LL3.

In FIG. 1, when a mode signal MD indicates a first mode, the ROI control unit 12 selects, as control target images, the frequency component images HH1, HL1, LH1, which are obtained by the first wavelet transform, out of the frequency component images HH1, HL1, LH1, HH2, HL2, LH2, HH3, HL3, LH3, LL3, and sets regions corresponding to the region of interest and regions corresponding to the region of non-interest in the frequency component images HH1, HL1, LH1 in a unit of a predetermined coding block (for example, horizontal 8 pixels×vertical 8 pixels). Note that the mode signal MD is a signal indicating a mode of a ROI function and is supplied from, for example, a CPU or the like (not shown) controlling the whole image coding device 10. When the mode signal MD indicates the first mode as well as the wavelet transform unit 11 outputs the wavelet transform coefficients of the regions corresponding to the region of non-interest in the frequency component images HH1, HL1, LH1, the ROI control unit 12 activates a mask request signal MSKRQ.

On the other hand, when the mode signal MD indicates a second mode, the ROI control unit 12 selects, as the control target image, the frequency component image LL3 obtained by the third wavelet transform, which corresponds to the lowest frequency component, out of the frequency component images HH1, HL1, LH1, HH2, HL2, LH2, HH3, HL3, LH3, LL3, and sets a region corresponding to the region of interest and a region corresponding to the region of non-interest in the frequency component image LL3 in the unit of the coding block. When the mode signal MD indicates the second mode as well as the wavelet transform unit 11 outputs the wavelet transform coefficients of the region corresponding to the region of non-interest in the frequency component image LL3, the ROI control unit 12 activates the mask request signal MSKRQ.

In an activation period of the mask request signal MSKRQ supplied from the ROI control unit 12, the mask unit 13 changes the wavelet transform coefficients supplied from the wavelet transform unit 11 to a zero value to output them to the quantization unit 14. In a deactivation period of the mask request signal MSKRQ, the mask unit 13 outputs, to the quantization unit 14, the wavelet transform coefficients supplied from the wavelet transform unit 11 without changing them.

Therefore, as shown in FIG. 3(a), when the mode signal MD indicates the first mode as well as the wavelet transform coefficients supplied from the wavelet transform unit 11 are the wavelet transform coefficients of the regions (hatched portions in FIG. 3(a)) corresponding to the region of non-interest in the frequency component images HH1, HL1, LH1, the mask unit 13 changes these wavelet transform coefficients to the zero value to output them.

Further, as shown in FIG. 3(b), when the mode signal MD indicates the second mode as well as the wavelet transform coefficients supplied from the wavelet transform unit 11 are the wavelet transform coefficients of the region (hatched portion in FIG. 3(b)) corresponding to the region of non-interest in the frequency component image LL3, the mask unit 13 changes these wavelet transform coefficients to the zero value to output them.

In FIG. 1, the quantization unit 14 quantizes the wavelet transform coefficients supplied from the mask unit 13 with a predetermined quantization step size to output them to the entropy coding unit 15. The entropy coding unit 15 stores quantized coefficients (the quantized wavelet transform coefficients) supplied from the quantization unit 14, in a buffer memory or the like (not shown). The entropy coding unit 15 reads the quantized coefficients from the buffer memory in the unit of the coding block, and applies entropy coding to a plurality bit planes constituting the quantized coefficients in order from an upper-order bit plane. The entropy coding unit 15 outputs to the coded stream generating unit 16 coded data that are generated as a result of the entropy coding.

When the mode signal MD indicates the first mode, the ROI control unit 12 sets the regions corresponding to the region of interest and the regions corresponding to the region of non-interest in the frequency component images HH1, HL1, LH1 in the unit of the coding block, and therefore, there is no such a case where the quantized coefficients of the coding block that is a processing target of the entropy coding unit 15 include both the quantized coefficients of the regions corresponding to the region of interest and the quantized coefficients of the regions corresponding to the region of non-interest in the frequency component images HH1, HL1, LH1. Further, when the mode signal MD indicates the first mode, the mask unit 13 changes the wavelet transform coefficients of the regions corresponding to the region of non-interest in the frequency component images HH1, HL1, LH1 to the zero value, and therefore, when the quantized coefficients of the coding block that is the processing target of the entropy coding unit 15 are the quantized coefficients of the regions corresponding to the region of non-interest in the frequency component images HH1, HL1, LH1, these quantized coefficients have the zero value.

Therefore, when the mode signal indicates the first mode as well as the quantized coefficients of the coding block that is the processing target are the quantized coefficients of the regions corresponding to the region of non-interest in the frequency component images HH1, HL1, LH1, the entropy coding unit 15 can process all the bit planes constituting the quantized coefficients of the coding block that is the processing target, as zero bit planes. In such a case, the entropy coding unit 15 generates information indicating that all the bit planes constituting the quantized coefficients of the coding block that is the processing target are the zero bit planes and outputs the information to the coded stream generating unit 16, without generating the coded data.

Similarly, when the mode signal MD indicates the second mode, the ROI control unit 12 sets the region corresponding to the region of interest and the region corresponding to the region of non-interest in the frequency component image LL3 in the unit of a coding unit, and therefore, there is no such a case where the quantized coefficients of the coding block that is the processing target of the entropy coding unit 15 include the quantized coefficients of both the region corresponding to the region of interest and the region corresponding to the region of non-interest in the frequency component image LL3. Further, when the mode signal MD indicates the second mode, the mask unit 13 changes the wavelet transform coefficients of the region corresponding to the region of non-interest in the frequency component image LL3 to the zero value, and therefore, when the quantized coefficients of the coding block that is the processing target of the entropy coding unit 15 are the quantized coefficients of the region corresponding to the region of non-interest in the frequency component image LL3, these quantized coefficients have the zero value.

Therefore, when the mode signal MD indicates the second mode as well as the quantized coefficients of the coding block that is the processing target are the quantized coefficients of the region corresponding to the region of non-interest in the frequency component image LL3, the entropy coding unit 15 can process all the bit planes constituting the quantized coefficients of the coding block that is the processing target, as the zero bit planes.

In order to make a coded stream to be newly generated conform to a target bit rate, the coded stream generating unit 16 discards part of the coded data supplied from the entropy coding unit 15 as required and combines the remaining portion of the coded data with the information on the zero bit planes and information on coding conditions such as the quantization step size to generate the coded stream.

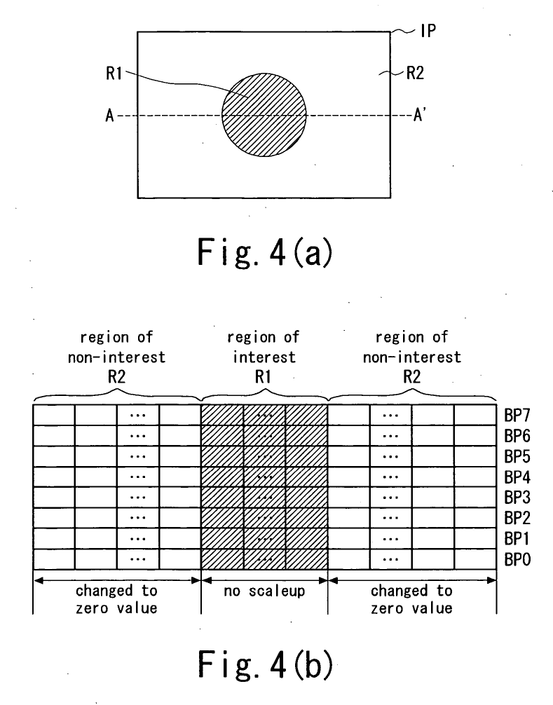

FIG. 4(a) and FIG. 4(b) show an overview of coding processing in the embodiment of the present invention. FIG. 4(a) shows an example of an input image. FIG. 4(b) shows an overview of coding processing for a pixel group on the A-A′ line in FIG. 4(a).

When receiving an input image IP (an image constituted of a region R1 of interest and a region R2 of non-interest) as shown in FIG. 4(a), the image coding device 10 as structured above does not scale up data (for example, 8-bit data) of pixels belonging to the region R1 of interest on the A-A′ line in FIG. 4(a) (does not change the bit plane structure), while changing data of pixels belonging to the region R2 of non-interest on the A-A′ line in FIG. 4(a) to the zero value, and in this state, applies the coding processing to 8 bit planes BP0 to BP7, as shown in FIG. 4(b).

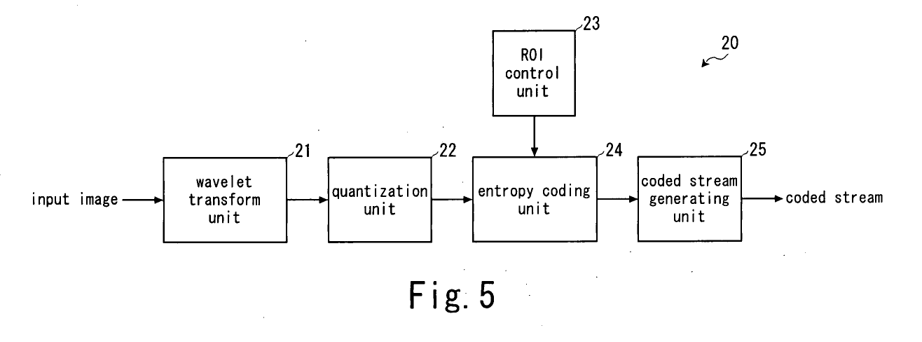

FIG. 5 shows a comparative example of the present invention. An image coding device 20 in the comparative example of the present invention includes a wavelet transform unit 21, a quantization unit 22, a ROI control unit 23, an entropy coding unit 24, and a coded stream generating unit 25. The image coding device 20 is an image coding device in conformity with, for example, the JPEG2000 standard, similarly to the image coding device 10 in the embodiment of the present invention.

The wavelet transform unit 21 and the quantization unit 22 are the same as the wavelet transform unit 11 and the quantization unit 14 in the embodiment of the present invention. The ROI control unit 23 sets the regions corresponding the region of interest in the frequency component images HH1, HL1, LH1, HH2, HL2, LH2, HH3, HL3, LH3, LL3 in a unit of a pixel. The ROI control unit 23 outputs, to the entropy coding unit 24, coordinate information for determining the regions corresponding to the region of interest in the frequency component images HH1, HL1, LH1, HH2, HL2, LH2, HH3, HL3, LH3, LL3 and information indicating a scale-up amount of the quantized coefficients of the regions corresponding to the region of interest in the frequency component images HH1, HL1, LH1, HH2, HL2, LH2, HH3, HL3, LH3, LL3.

As for the quantized coefficients supplied from the quantization unit 22 (quantized wavelet transform coefficients), the entropy coding unit 24 scales up the quantized coefficients of the regions corresponding to the region of interest in the frequency component images HH1, HL1, LH1, HH2, HL2, LH2, HH3, HL3, LH3, LL3, based on the information supplied from the ROI control unit 23, and stores the scaled-up quantized coefficients in a buffer memory or the like (not shown). The entropy coding unit 24 reads the quantized coefficients from the buffer memory in a unit of a predetermined coding block and applies entropy coding to a plurality of bit planes constituting the quantized coefficients in order from an upper-order bit plane. The entropy coding unit 24 outputs to the coded stream generating unit 25 coded data generated as a result of the entropy coding. The coded stream generating unit 25 is the same as the coded stream generating unit 16 in the embodiment of the present invention.

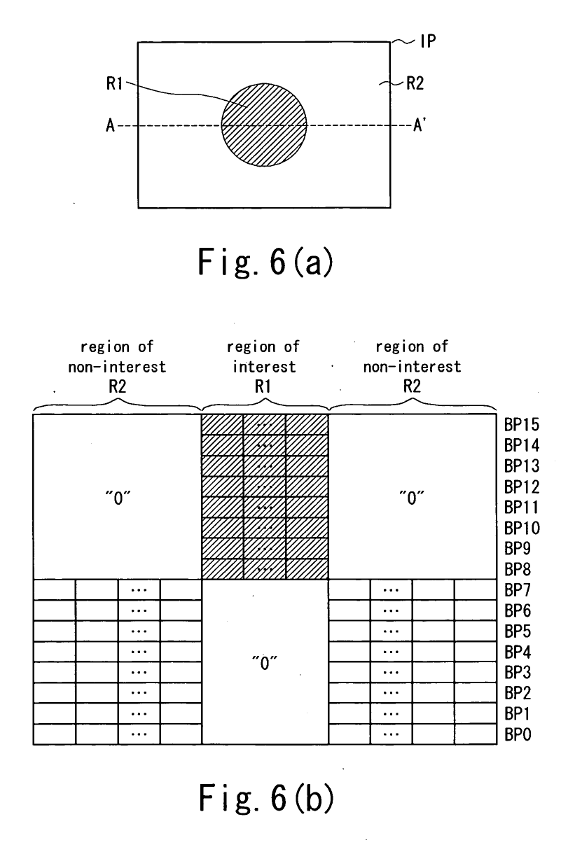

FIG. 6(a) and FIG. 6(b) show an overview of coding processing in the comparative example of the present invention. FIG. 6(a) shows an example of an input image. FIG. 6(b) shows an overview of coding processing for a pixel group on the A-A′ line in FIG. 6(a).

When receiving the input image IP (image constituted of the region R1 of interest and the region R2 of non-interest) as shown in FIG. 6(a), the image coding device 20 as structured above scales up data (for example, 8-bit data) of pixels belonging to the region R1 of interest on the A-A′ line in FIG. 6(a) by 8 bits, and in this state, applies the coding processing to 16 bit planes BP0˜PB15, as shown in FIG. 6(b). In this case, the data of the pixels belonging to the region R1 of interest in the bit planes BP0˜BP7 are set to a zero value (“0”). Similarly, the data of pixels belonging to the region R2 of non-interest in the bit planes BP8˜PB15 are set to the zero value.

In the comparative example of the present invention as described above, a data volume of the coded data is adjusted when the coded stream is generated in the coded stream generating unit 25, and accordingly, image quality in the coded data greatly changes according to a data volume of the region of interest in the input image. Further, when the entropy coding is executed, the quantized coefficients of the regions corresponding to the region of interest in the frequency component images HH1, HL1, LH1, HH2, HL2, LH2, HH3, HL3, HL3, LH3, LL3 have been scaled up, which increases the number of the bit planes to be processed by the entropy coding. Further, since the ROI processing is applied to all the frequency component images HH1, HL1, LH1, HH2, HL2, LH2, HH3, HL3, LH3, LL3, the coordinate information for determining the regions corresponding to the region of interest has to be generated for all the frequency component images HH1, HL1, LH1, HH2, HL2, LH2, HH3, HL3, LH3, LL3. As a result, a circuit configuration for realizing the ROI function becomes complicated.

On the other hand, in the embodiment of the present invention previously described, the wavelet transform coefficients of the region corresponding to the region of non-interest in each of the control target images (the first mode: the frequency component images HH1, HL1, LH1, the second mode: the frequency component image LL3) are changed to the zero value, and therefore, it is possible to prevent image quality of the region of non-interest in the coded data from greatly changing according to a data volume of the region of interest in the input image.

Since the entropy coding is executed without scaling up the wavelet transform coefficients of the regions corresponding to the region of interest in each of the control target images, the number of the bit planes to be processed by the entropy coding can be reduced. Further, the region corresponding to the region of interest and the region corresponding to the region of non-interest in each of the control target images are set in the unit of the coding block; therefore, the single processing can be applied in the coding block when the bit plane coding is executed. Further, the frequency component images obtained by the initial (first time) or the final (third time) wavelet transform are selected as the control target images, and therefore, the coordinate information for determining the regions corresponding to the region of interest needs to be generated only for these frequency component images, which can reduce the processing for generating the coordinate information. As a result, the ROI function can be realized with a simple circuit configuration.

Further, when the mode signal MD indicates the first mode, only the wavelet transform coefficients of the regions corresponding to the region of non-interest in the frequency component images HH1, HL1, LH1 obtained by the first wavelet transform, which correspond to the high frequency components, are changed to the zero value. This can minimize deterioration in image quality of the region of non-interest in the coded data. In addition, the wavelet transform coefficients of the frequency component images HH1, HL1, 20 LH1 have a large data volume, and accordingly, selecting the frequency component images HH1, HL1, LH1 as the control target images makes it possible to increase a compression ratio of the coded data as a ratio of the region of non-interest in the input image is larger.

When the mode signal MD indicates the second mode, only the wavelet transform coefficients of the region corresponding to the region of non-interest in the frequency component image LL3 obtained by the final wavelet transform, which corresponds to the lowest frequency component, are changed to the zero value. Consequently, the region of non-interest in the coded data becomes a gray image, so that the mask function for the region of non-interest in the input image can be realized.

The above embodiment of the present invention has described the example where the modes set as the ROI function mode are: the first mode in which only the frequency component images HH1, HL1, LH1 obtained by the first wavelet transform are selected as the control target images; and the second mode in which only the frequency component image LL3 obtained by the final wavelet transform, which corresponds to the lowest frequency component, is selected as the control target image, but the present invention is not limited to such an embodiment. According to image quality required for the region of non-interest in the coded data or a data volume required for the coded data, other modes may be provided as the ROI function mode, for example, a mode in which part of the frequency component images HH2, HL2, LH2, HH3, HL3, LH3, LL3 is selected as the control target image in addition to the frequency component images HH1, HL1, LH1, or a mode in which part of the frequency component images HH1, HL1, LH1, HH2, HL2, LH2, HH3, HL3, LH3 is selected as the control target image in addition to the frequency component image LL3.

Further, the above embodiment of the present invention has described the example where the image coding device is realized by dedicated hardware constituting each of the function units, but the present invention is not limited to such an embodiment. For example, each of the function units may be configured by installing dedicated programs in a programmable processor, or each of the function units may be configured by software.

The invention is not limited to the above embodiments and various modifications may be made without departing from the spirit and scope of the invention. Any improvement may be made in part or all of the components.

What is claimed is:

1. An image coding method comprising:
a first step of transforming an input image constituted of a region of interest and a region of non-interest into a plurality of frequency component images through a plurality of wavelet transforms;
a second step of selecting a part of the plural frequency component images as control target images and setting, in a unit of a predetermined coding block, a region corresponding to said region of interest and a region corresponding to said region of non-interest in each of said control target images;
a third step of applying, to image data of the plural frequency component images, processing of changing, to a zero value, image data of the region corresponding to said region of non-interest in each of said control target images; and
a fourth step of applying, in the unit of the coding block, bit plane coding to the image data changed in said third step without changing a bit plane structure, to generate coded data.

2. An image coding method according to claim 1, wherein
in said second step, the frequency component image obtained through any one of the plural wavelet transforms is selected from the plural frequency component images as the control target image.

3. The image coding method according to claim 2, wherein
in said second step, the frequency component image obtained through a first one of the plural wavelet transforms is selected from the plural frequency component images as the control target image.

4. The image coding method according to claim 2, wherein in said second step, the frequency component image of a lowest frequency component obtained through a final one of the plural wavelet transforms is selected from the plural frequency component images as the control target image.

5. An image coding device comprising:
a transform unit transforming an input image constituted of a region of interest and a region of non-interest into a plurality of frequency component images through a plurality of wavelet transforms;
a setting unit selecting a part of the plural frequency component images as control target images and setting, in a unit of a predetermined coding block, a region corresponding to said region of interest and a region corresponding to said region of non-interest in each of said control target images;
a changing unit applying, to image data of the plural frequency component images, processing of changing, to a zero value, image data of the region corresponding to said region of non-interest in each of said control target images; and
a coding unit applying, in a unit of the coding block, bit plane coding to the image data changed by said changing unit without changing a bit plane structure, to generate coded data.

6. The image coding device according to claim 5, wherein
said setting unit selects, as the control target image, the frequency component image obtained through any one of the plural wavelet transforms from the plural frequency component images.

7. The image coding device according to claim 6, wherein
said setting unit selects, as the control target image, the frequency component image obtained through a first one of the plural wavelet transforms from the plural frequency component images.

8. The image coding device according to claim 6, wherein
said setting unit selects, from the plural frequency component images, as the control target image, the frequency component image of a lowest frequency component obtained through a final one of the plural wavelet transforms.
